(19) United States
(12) Patent Application Publication
(10) Pub. No.: US 2024/0009813 A1
(43) Pub. Date: Jan. 11, 2024

(54) POWER TOOL

(71) Applicant: TECHTRONIC CORDLESS GP, Anderson, SC (US)

(72) Inventors: Matthew Samstag, Anderson, SC (US); Gui Fang Zhou, Dongguan City (CN); Carl Chandler, Greenville, SC (US)

(21) Appl. No.: 18/348,907

(22) Filed: Jul. 7, 2023

(30) Foreign Application Priority Data
Jul. 11, 2022 (CN) 202221781021.8

(51) Int. Cl. B25B 21/00; B25B 13/46

(52) U.S. Cl. CPC B25B 21/004; B25B 13/465

(57) ABSTRACT

A power tool comprises an input member, an output member and an actuating member, ratchet teeth being provided on an inner circumference of the input member, a pawl being disposed on an outer circumference of the output member, the actuating member capable of abutting against different portions of the pawl to respectively cause the pawl to be positioned in a first position and a second position relative to the input member, wherein the actuating member is offset from a central axis of the input member.

### TECHNICAL FIELD

The present disclosure relates to the field of small industrial tools, and specifically to a power tool.

### BACKGROUND

At present, some power tools such as ratchet wrenches for transmission through engagement of a ratchet and a pawl are commonly available in the market. For a conventional ratchet wrench, ratchet teeth are usually formed on an outer circumference of the ratchet, and the pawl is positioned outside the ratchet to engage with the ratchet teeth. Such a ratchet wrench is inconvenient to operate upon switching the rotation output direction, and likely to cause the pawl to displace relative to the ratchet, thereby causing the transmission mechanism to fail.

There are also some ratchet wrenches in which ratchet teeth are formed on the inner circumference of the ratchet wheel and the pawl is surrounded by the ratchet wheel. In this type of ratchet wrench, an actuating mechanism for actuating the pawl is usually located at a central position of the ratchet wheel. In order to enable full engagement of the actuating member and the pawl, the wall of the member receiving the pawl can only be made thick so that the ratchet wrench is not light enough; in addition, with the actuating mechanism being disposed at the central position, the central position is unable to receive an idle end of a double-ended tool.

Therefore, it is desirable to provide a ratchet wrench to at least partially solve the above problems.

### SUMMARY

An object of the present disclosure is to provide a power tool which achieves the switching of a torque output direction through selective engagement of a pawl and ratchet teeth between an input member and an output member. Different from the conventional ratchet and pawl transmission, ratchet teeth are provided on an inner circumference of the annular input member of the present disclosure, the input member surrounds the output member, and the pawl and the ratchet teeth engage at inner side the input member. Due to such an arrangement, the positional relationship between the input member and the output member is stable so that they are not prone to disengage; it is easier for an operator to switch the torque transmission direction, and it is easy to ensure the full contact and engagement of the pawl and the ratchet; the performance and service life of the power tool can be optimized. The present disclosure still further provides various preferred arrangements regarding the switching of the torque transmission direction to meet various use and production demands.

Moreover, in the present disclosure, the actuating member for actuating the pawl is disposed offset from the center axis, that is, the actuating member is located at an off-center position of the output member. The actuating member for example may be disposed within the hollow output member main body to drive the pawl here, so that the output member may have a thinner wall and the power tool is lighter. The actuating member makes room for the central space of the output member to allow the central space to receive an idle end of a double-ended tool head; the wall of the output member is thin so that the output member has a larger inner diameter and can receive the idle end of the tool head having more sizes.

The present disclosure still further provides various preferred arrangements for the switching of the torque transmission direction to meet various use and production demands.

According to one aspect of the present disclosure, there is provided a power tool, comprising:
an input member substantially constituting an annular shape and configured to be driven by a power source of the power tool to rotate in a first direction and a second direction opposite to the first direction, ratchet teeth being disposed on an inner circumference of the input member;
an output member surrounded by the input member and configured to mount a tool head thereon to move the tool head, the output member comprising a pawl having a first pawl portion and a second pawl portion,
an actuating member capable of abutting against different portions of the pawl to respectively cause the pawl to be positioned in a first position and a second position relative to the input member, wherein the actuating member is offset from a central axis of the input member,
wherein when the pawl is retained in the first position, the first pawl portion engages with the ratchet teeth to only allow rotation of the input member in the first direction to be transmitted to the output member; when the pawl is retained in the second position, the second pawl portion engages with the ratchet teeth to only allow rotation of the input member in the second direction to be transmitted to the output member.

In one embodiment, the output member comprises a substantially cylindrical hollow output member main body, a receiving groove is provided on a side surface of the output member main body, the pawl is disposed in the receiving groove, and the actuating member is located at least partially in the output member main body,
especially, a wall thickness of the output member main body is 5 mm-9 mm, preferably 6.5-7.5 mm, 5 mm-6 mm or 8 mm-9 mm.

In one embodiment, the power tool further comprises an operation member for a user to operate to drive the actuating member,
preferably, the actuating member is configured to elastically apply a force on the pawl.

In one embodiment, the actuating member abuts against the operation member.

In one embodiment, the actuating member comprises two actuating members, wherein:
each of the actuating members comprises an arcuate structure extending about the central axis, and preferably the actuating member comprises a spring and a rigid force-applying section in direct contact with the pawl, and optionally an end of the force-applying section abuts against an end of the spring, or the force-applying section has a portion extending into an interior of the spring; or
each of the actuating members comprises a linear structure, and preferably the actuating member comprises a spring and a spring sleeve for partially receiving the spring and applying a force to the pawl.

In one embodiment, the actuating member is an annular member substantially surrounding the central axis and having an opening, and the actuating member is positioned such that the pawl is disposed in the opening so that both ends of the actuating member can respectively contact the pawl.

In one embodiment, the operation member is exposed out of a top of the power tool, and an actuating member groove extending in a plane perpendicular to the central axis and allowing the actuating member to move therein is disposed in the output member main body, wherein:
the operation member has an extension section extending towards a bottom side to the actuating member groove, the extension section being configured to abut against the actuating member in a circumferential direction; or
the actuating member has an extension section extending toward a top side out of the actuating member groove so that the operation member can abut against the extension section in a circumferential direction,
preferably, the extension section is an arcuate section extending about the axis,
preferably, the power tool comprises a housing whose top is provided with a protective protrusion at least partially surrounding the operation member.

In one embodiment, the actuating member is the linear structure, the operation member has the extension section, and a surface of a distal end of the extension section facing the actuating member is substantially perpendicular to an extension direction of the actuating member.

In one embodiment, the operation member is a knob, two recessed portions are formed on a bottom surface of a body of the knob, elastic protrusions are provided on a top surface of the output member; when the elastic protrusions are partially placed in the recessed portions, the knob is fixed relative to the output member to retain the actuating member in place.

In one embodiment, the pawl is configured to swing about a pivot fixed to the output member main body, the pawl comprises a first wing portion and a second wing portion located on both sides of the pivot, the first pawl portion is formed on an outer side surface of a circumferential end portion of the first wing portion, and the second pawl portion is formed on an outer side surface of a circumferential end portion of the second wing portion, wherein
the actuating member is capable of abutting against an inner side surface of the circumferential end portion of the first wing portion to retain the pawl in the first position, and capable of abutting against an inner side surface of the circumferential end portion of the second wing portion to retain the pawl in the second position, or
the actuating member is capable of abutting agents a pivot mounting portion of the pawl to retain the pawl in the first position or the second position,
preferably, the pivot is parallel to the axis.

In one embodiment, the operation member and the actuating member are connected as one piece via a rod portion,

Preferably, the operation member comprises a toggle block exposed outward at the top of the power tool, the actuating member comprises a pin, a force-applying end of the pin in contact with the pawl is provided with an elastic contact, and the pin is driven to pivot about a straight line where an extension direction of the rod portion lies, when the toggle block is toggled.

In one embodiment, the pawl is a substantially arcuate structure surrounding the rod portion and is capable of swinging around the rod portion, the first pawl portion and the second pawl portion are respectively formed on an outer side surface of a circumferential end portion of the pawl, and the actuating member can abut against the inner side surface of the pawl to retain the pawl at the first position and the second position,

Preferably, the inner side surface of the pawl is an arcuate surface surrounding the rod portion,

Preferably, the rod portion is parallel to the axis.

In one embodiment, when the actuating member is retained in a way that the pawl is located in the first position or the second position, the operation member makes room for a top space of the tool head to allow the tool head to extend outward from the top of the power tool to serve as an output end, and the tool head can also extend outward from the bottom of the power tool to serve as an output end.

In one embodiment, the power tool comprises a replacement operation assembly operable to allow the tool head to be replaced, particularly both ends of the tool head have different dimensions, and the power tool allows the tool head to be mounted on the power tool with different ends as output; especially, radial dimensions of both ends of the power tool may be 6 mm-7 mm and 9 mm-10 mm, respectively.

In one embodiment, a portion of the tool head extending out of the output member has a cylindrical section that is radially inwardly recessed relative to portions at its both axial side, and
the replacement operation assembly comprises a tongue, a distal end of the tongue is a concave arc adapted to the cylindrical portion, and the tongue is configured to extend towards and retract from the cylindrical portion,
wherein, when the tongue is engaged on the cylindrical portion, the tool head is allowed to rotate but axial movement of the tool head is limited; when the tongue is disengaged from the cylindrical portion, the tool head is allowed to moved axially to be replaced.

In one embodiment, the power tool is a wrench, the power source is a manual power source or an electric power source, particularly the input member swings alternately in the first direction and the second direction, and particularly an eccentric transmission mechanism is disposed between the power source and the input member.

### BRIEF DESCRIPTION OF THE DRAWINGS

Reference may be made to preferred embodiments shown in the figures to enable better understanding of the above and other objects, features, advantages and functions of the present disclosure. The same reference numerals in the figures denote the same parts. Those skilled in the art should appreciate that the figures are intended to schematically illustrate the preferred embodiments of the present disclosure, and not intended to impose any limitations to the scope of the present disclosure. All parts in the figures are not drawn to scale.

FIG. 1A is a schematic diagram of a partial structure of a power tool according to an embodiment of the present disclosure;

FIG. 1B is a schematic diagram of an alternative solution of FIG. 1A;

FIG. 2 is a perspective view of the structure in FIG. 1 as viewed from a top perspective;

FIG. 3 is a perspective view of the structure in FIG. 1A as viewed from a bottom perspective;

FIG. 4A is a perspective view after a housing of the power tool shown in FIG. 1A is removed.

FIG. 4B is a combined schematic diagram of an input member and an output member in FIG. 4A;

FIG. 5 is an exploded schematic view of the input member and the output member in FIG. 4A;

FIG. 6A is a cross-sectional view taken along line A-A in FIG. 1A;

FIG. 6B shows a structure of an alternative solution of an actuating member of FIG. 6A;

FIG. 7 is a perspective view showing an operation member shown in FIG. 4 acts on an actuating member;

FIG. 8A is a perspective view as viewed from a top perspective after the operation member in FIG. 4A is removed;

FIG. 8B is a perspective view as viewed from a bottom perspective of the operation member in FIG. 4A;

FIG. 9 is a perspective schematic view of a tool head alone shown in FIG. 1A;

FIG. 10A is a cross-sectional view according to another embodiment of the present disclosure, and FIG. 10A has the same cross-sectional view angle as FIG. 6A;

FIG. 10B is a perspective view of an actuating member and a pawl of the structure in FIG. 10A;

FIG. 11 is a perspective view of an actuating member and a pawl according to another embodiment of the present disclosure;

FIG. 12A is a perspective view of the output member in a further embodiment;

FIG. 12B is a schematic diagram of the combination of the operation member, the output member and the actuating member in the further embodiment.

FIG. 13 is a schematic view from a top perspective of a partial structure of a power tool according to a fourth embodiment of the present disclosure;

FIG. 14 is a view in which the input member and the output member in FIG. 13 cooperate each other;

FIG. 15 is a view in which the input member, the pawl, the operation member and the actuating member in FIG. 14 cooperate one another;

FIG. 16 is an exploded view of other parts after the input member is omitted in FIG. 15.

### DETAILED DESCRIPTION

Specific embodiments of the present prevention will now be described in detail with reference to the figures. What are described here are only preferred embodiments according to the present disclosure. Those skilled in the art can implement other embodiments of the present disclosure on the basis of the preferred embodiments, and said other embodiments also fall within the scope of the present disclosure.

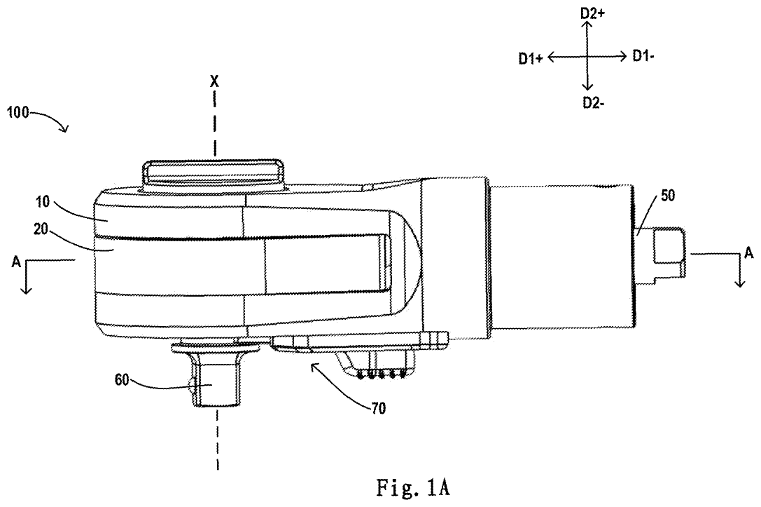

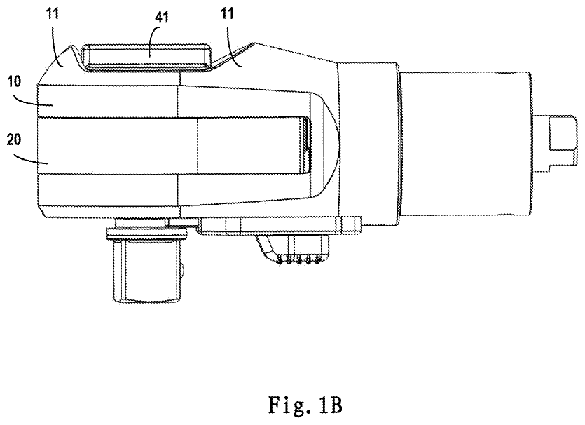

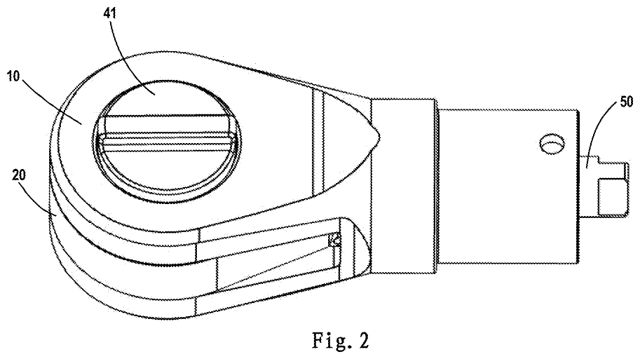

FIG. 1A-FIG. 16 show some preferred embodiments of the power tool according to the present disclosure. For example, the power tool of the present disclosure is a ratchet wrench which may be an electric ratchet wrench or a manual ratchet wrench. First of all, it needs to be appreciated that directional terms and position terms in the present disclosure should be understood as indicating relative directions and positions, rather than absolute directions and positions. The directional terms and position terms in the present disclosure may be explained with reference to the exemplary structures shown in FIG. 1A-FIG. 1A6. For example, an axis direction and an axial direction of an input member mentioned in the present disclosure are shown by X in the figures, a radial direction and a circumferential direction are the radial direction and the circumferential direction about the axis X; a distal direction is a direction away from the user upon operation and for example may be a D1+ direction in FIG. 1A; a proximal direction is a direction toward the user upon operation, and for example may be a D1− direction in FIG. 1A; a direction toward a top side or a top for example may be a D2+ direction in the figure; a direction toward a bottom side or a bottom for example may be a D2− direction in the figure, wherein the D2+ direction and D2− direction are extension directions parallel to the axis X. In addition, “first” and “second” in the present disclosure are only used for distinguishing purpose in terminology and do not imply or suggest any sequential order.

FIG. 1A to FIG. 9 show a partial structure of a power tool 100 according to a first embodiment of the present disclosure. The power tool 100 is for example a ratchet wrench, which may be specifically an electric ratchet wrench or a manual ratchet wrench. The power tool 100 may include a power portion, a transmission portion and an output portion connected in sequence from a proximal side to a distal side, and the tool head 60 can be attached to the output portion so that the power tool 100 can output a torque outwardly through the tool head 60. The tool head 60 may for example extend from the bottom of the power tool 100. Only the output portion and part of the transmission portion are shown in FIGS. 1-9, and the power portion of the power tool 100 is omitted.

Referring first to FIG. 1A-FIG. 3, the power tool 100 includes a housing 10, which may simply be the housing 10 at the output portion of the power tool 100. Alternatively, the power tool 100 may include a one-piece housing that integrally covers the power portion, the transmission portion, and the output portion.

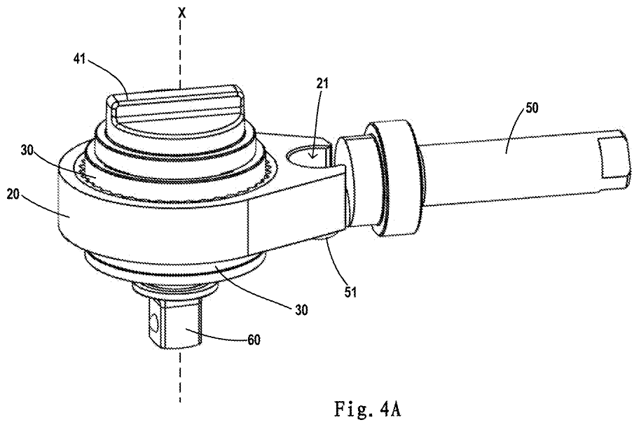

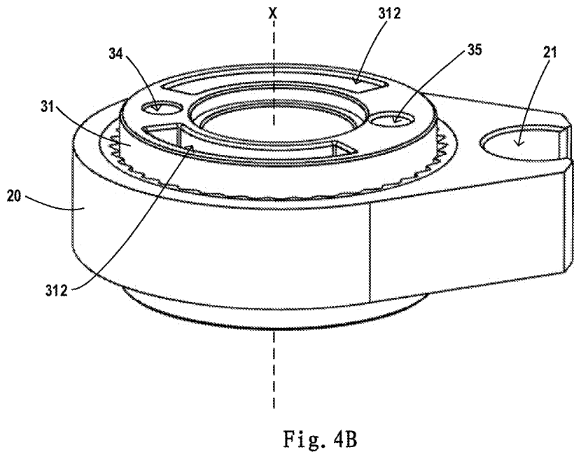

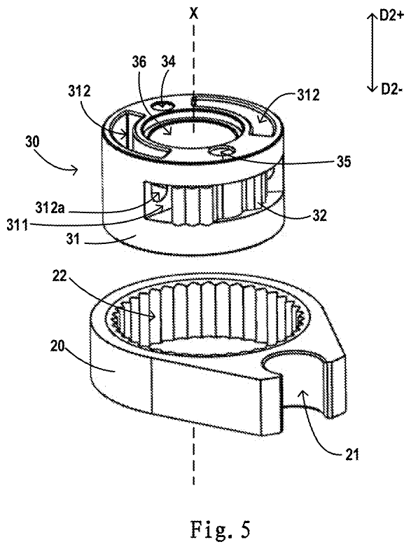

FIG. 4A shows the structure after the housing 10 in FIG. 1A-FIG. 3 is removed. It can be seen from FIG. 4A that the output portion of the power tool 100 includes an input member 20, an output member 30 and an operation member 41. FIG. 4B and FIG. 5 respectively show a schematic diagram of a combined state and a schematic diagram of an exploded state of the input member 20 and the output member 30 in FIG. 4A.

Referring to FIG. 4A-FIG. 5, the input member 20 substantially constitutes an annular shape and can be driven by a power source of the power tool 100 to rotate. For example, the input member 20 may be engaged with an output end of the transmission portion. In some embodiments, the transmission portion, as an eccentric transmission mechanism, for example includes a transmission rod 50 and an eccentric wheel 51 mounted at a distal end of the transmission rod 50. For example, a proximal end of the input member 20 may protrude slightly and be formed with an eccentric wheel receiving groove 21 opening towards a proximal side to receive the eccentric wheel 51. The eccentric wheel 51 can rotate in the eccentric wheel receiving groove 21 to drive the input member 20 to swing about an axis X. Ratchet teeth 22 are provided on an inner circumference of the input member 20. It can be seen from FIG. 1A-FIG. 3 that the outer circumference of the input member 20 is generally flush with the housing 10 to define a smooth outer contour of the power tool 100 together with the housing 10.

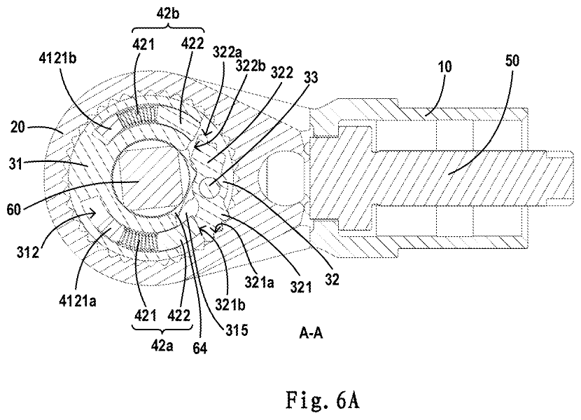

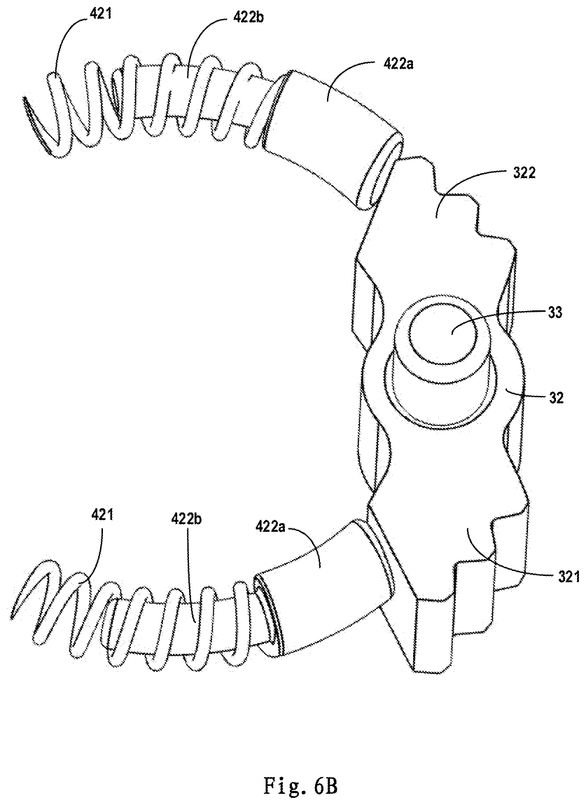

The output member 30 is surrounded by the annular input member 20 and is configured to mount the tool head 60 thereon to move the tool head 60. Referring to FIG. 5, the output member 30 may include an output member main body 31 and a pawl 32. The output member main body 31 is a substantially cylindrical hollow body, a pawl receiving groove 311 is provided on a side surface of the output member main body 31, and the pawl 32 is disposed in the pawl receiving groove 311. The operation member 41 can be operated by the user to actuate the pawl 32 via the actuating member 42. The pawl 32, when pushed by the actuating member 42, rotate slightly relative to the output member main body 31 about a pivot 33 (see FIG. 6A) to achieve switch between a first position and a second position. The pawl 32 has a first pawl portion 321a and a second pawl portion 322a located on both sides of the pivot 33, respectively (see FIG. 6A). When the pawl 32 is retained in the first position, the first pawl portion 321a can engage with the ratchet teeth 22 to only allow rotation of the input member 20 in a first direction to be transmitted to the output member 30; when the pawl 32 is retained in the second position, the second pawl portion 322a engages with the ratchet teeth 22 to only allow rotation of the input member 20 in a second direction to be transmitted to the output member 30. The first direction and the second direction are opposite directions around the axis X. The pivot 33 is preferably parallel to the axis X.

That is to say, during the switching of the torque output direction, the input member 20 and the output member main body 31 are fixed relative to each other, and the pawl 32 rotates slightly relative to the output member main body 31 and the input member 20; after the torque output direction is determined (i.e., when the pawl 32 is retained in the first position or the second position), the pawl 32 is fixed relative to the output member main body 31, thereby driving the output member main body 31 to rotate together relative to the input member 20 around the axis X. While in some embodiments the pawl 32 and the output member main body 31 are two parts assembled together, the output member may be a one-piece member whose side is provided with a pawl in some other embodiments not shown.

It may be appreciated that the power tool 100 realizes the switching of the torque output direction through selective engagement of the pawl 32 and ratchet teeth 22 between the input member 20 and the output member 30. In some preferred embodiments, the actuating member 42 can elastically apply a force to the pawl 32. The actuating member 42 abuts against a force-applying end at the bottom of the operation member 41 to switch between a first state and a second state driven by the movement of the operation member 41. Referring to FIG. 6A, for example, there may be two actuating members 42 which are respectively located at a first side surface 321b and a second side surface 322b of the pawl 32. When the first actuating member 42a is pushed by a first force-applying end 4121a of the operation member 41, the first actuating member 42a is in a compressed state and abuts against the first side surface 321b of the pawl 32 to keep it in the first position, the second actuating member 42b is in a natural state, and the state of the first actuating member 42a and the second actuating member 42b is referred to as the first state; it is conceivable that when the second actuating member 42b is pushed by a second force-applying end 4121b of the operation member 41, the second actuating member 42b is in a compressed state and abuts against the second side surface 322b of the pawl 32 to keep it in the second position, the first actuating member 42a is in a natural state, and the state of the first actuating member 42a and the second actuating member 42b is referred to as the second state.

As can be seen from the cross-sectional view in FIG. 6A, in some embodiments, the pawl 32 includes wings 321, 322 located on both sides of the pivot 33, the first pawl portion 321a is formed on an outer side surface of a circumferential end portion of the wing 321, the first side surface 321b is formed on an inner side surface of the circumferential end portion of the wing 321; the second pawl portion 322a is formed on an outer side surface of the circumferential end portion of the wing 322, and the second side 322b is formed on an inner side surface of the circumferential end portion of the wing 322. When the first side surface 321b of the pawl 32 is pushed, the first pawl portion 321a swings slightly radially outward to engage with the ratchet teeth 22; when the second side surface 322b of the pawl 32 is pushed, the second pawl portion 322a swings slightly radially outward to engage ratchet 22. In other embodiments not shown, the pawls may also have other shapes.

When the power tool 100 operates normally, the operation member 41 is fixed relative to the output member main body 31. Taking the state shown in FIG. 6A as an example, at this time, the first force-applying end 4121a of the operation member 41 abuts against the first actuating member 42a, and the first actuating member 42a pushes the first pawl portion 321a of the pawl 32 to engage the ratchet teeth 22 of the input member 20. At this time, the operation member 41, the first actuating member 42a, the pawl 32, and the output member main body 31 cannot be displaced relative to one another, and constitute a whole. When the input member 20 swings, the ratchet 32 engages with the ratchet teeth 22 of the input member 20, and the pawl 32 can drive the whole composed of the operation member 41, the first actuating member 42a, the ratchet 32 and the output member main body 31 to rotate together. In some embodiments, the output member main body 31 is not in direct contact with the side surface of the pawl 32, but in other embodiments, the output member main body may abut against the side surface of the pawl during the rotation of the whole constituted by the output member and pawl.

In some embodiments, the input member 20 rotates reciprocally in the first direction and in the second direction, by a small amplitude of rotation each time, thereby exhibiting a oscillating motion as a whole. When the input member 20 rotates in the first direction, the pawl 32 engages with the ratchet teeth 22 to drive the output member 30 to rotate in the first direction; when the input member 20 rotates in the second direction, the pawl 32 slightly retreats (at this time, the first actuating member 42a is slightly compressed) out of engagement with the ratchet teeth 22, and rotation of the input member 20 in the second direction cannot be transmitted to the output member 30. This process continues reciprocally, so that the output member main body 31 intermittently rotates in the first direction. It needs to be appreciated that “the pawl 32 slightly retreats and the first actuating member 42a is slightly compressed” may be understood as a slight deformation of the output member 30 itself, and the operation member 41, the first actuating member 42a, the pawl 32, the output member main body 31 still constitute a whole in which the foregoing parts are fixed in position relative to one another.

Likewise, it may be understood that when the second pawl portion 322a of the pawl 32 is abutted against by the second actuating member 42b into engagement with the ratchet teeth 22 of the input member 20, only the rotation of the input member 20 in the second direction is transmitted to the output member 30, and the output member 30 will intermittently rotate in the second direction.

In other embodiments not shown, the input member may not perform an oscillating motion, but constantly rotate in the same direction. For example, when the torque in the first direction needs to be outputted outward, the first pawl portion of the pawl can be enabled to engage with the ratchet teeth of the input member, the power tool may be set to allow the input member to rotate in the first direction, and the rotation of the input member in the first direction can be constantly transmitted to the output member; when the torque in the second direction needs to be outputted outward, the second pawl portion of the pawl may be enabled to engage with the ratchet teeth of the input member, and the power tool may be set to allow the input member to rotate in the second direction, and rotation of the input member in the first direction can be constantly transmitted to the output member.

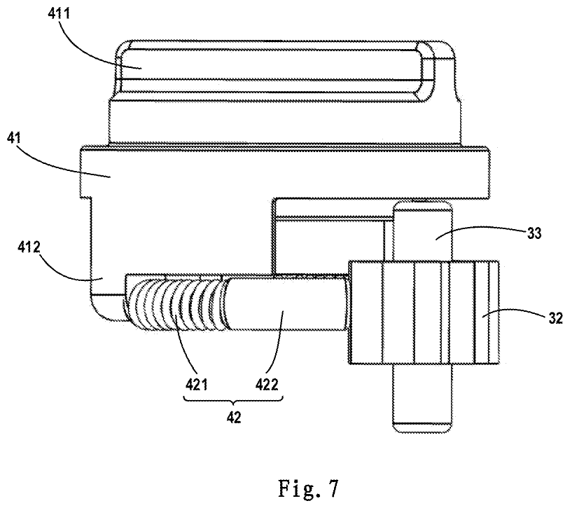

Further referring to FIG. 6A and FIG. 7, each actuating member 42 includes an arc-shaped structure extending around the axis X, preferably the actuating member 42 includes a spring 421 and a rigid force-applying section 422 configured in direct contact with the pawl 32, wherein the spring 421 and the force-applying section 422 each form an arc shape. Referring to FIG. 6A, in one embodiment, one end of the spring 421 may abut against one end of the force-applying section 422. In an alternative embodiment shown in FIG. 6B, the force-applying section may have a large-diameter section 422a and a small-diameter section 422b, the large-diameter section 422a contacts the pawl 32, and the small-diameter section 422b extends from the large-diameter section 422a into the spring 421 so that the spring 421 is sleeved on the outer circumference of the small-diameter section 422b. The spring 421 abuts against a shoulder which is of the large-diameter section 422a and is connected to the small-diameter section 422b.

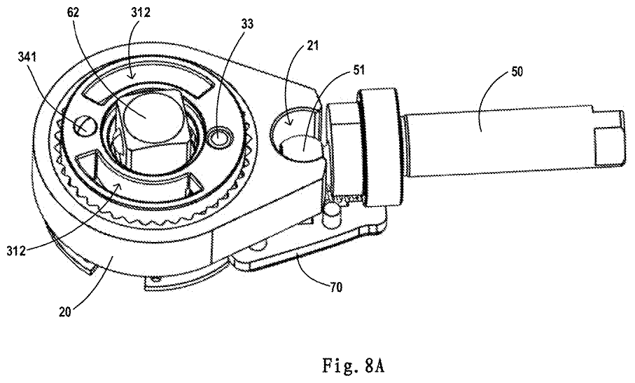

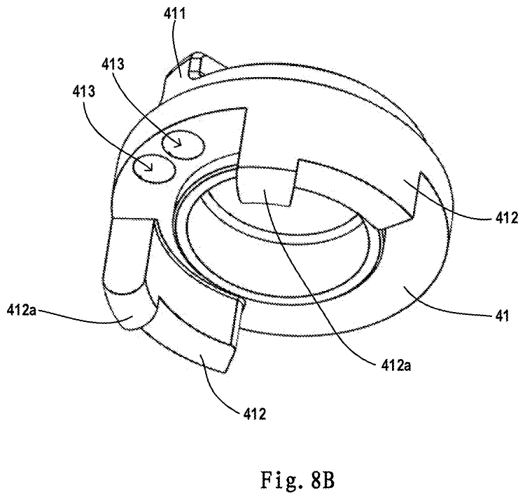

Referring to FIG. 4B, FIG. 5 and FIG. 8A, the output member main body 31 is provided with an actuating member groove 312 which is open at the top and extends about the axis X, and the actuating members 42 can be respectively received in the actuating member grooves 312 and rotate about the axis X in the groove. Furthermore, the actuating member groove 312 communicates with the pawl receiving groove 311 through a circumferential opening 312a (see FIG. 5), and the actuating member 42 can enter the pawl receiving groove 311 through the circumferential opening 312a to contact the pawl 32. Further referring to FIG. 5, the top of the output member main body 31 is provided with a hole 34 and a hole 35, the hole 34 is used to receive an elastic protrusion which will be described in detail later, and the hole 35 is used to mount the pivot 33 of the pawl 32. The holes 35 may be through holes or blind holes. A hole for receiving the pivot 33 is also provided at the position of the output member main body 31 below the pawl 32, and the hole may also be a through hole or a blind hole.

In some preferred embodiments, the operation member 41 may have some preferred settings. For example, referring to FIGS. 7 and 8B, the operation member 41 includes a knob 411 at the top and an extension section 412 extending from the knob 411 to the bottom side, an end of the extension section 412 being a force-applying end 412a. The extension section 412 may be an arc-shaped wall around the axis X, and the arc-shaped wall may be received by the actuating member groove 312 of the output member main body 31. Such an arrangement can ensure the stability of the operation member 41 upon rotation, and the operation member is not prone to shake. Certainly, in other embodiments not shown, the extension section 412 may be a simple elongated structure extending toward the bottom side.

Also preferably, referring to FIG. 8A and FIG. 8B, two recessed portions 413 are formed on the bottom surface of a body of the knob 411, and elastic protrusions 341 are provided on a top surface of the output member 30. When the elastic protrusions 341 are partially placed in the recessed portions 413, the knob 411 is fixed relative to the output member 30 to retain the actuating member 42 in the first state or the second state. When the user rotates the knob 411, the elastic protrusion 341 will be pressed down to allow the knob 411 to rotate.

Turning back to FIG. 1B, in some embodiments, the top of the housing 10 may be provided with a protective protrusion 11 at least partially surrounding the operation member 41, and the protective protrusion 11 can prevent the operation member 41 from being collided or mis-triggered.

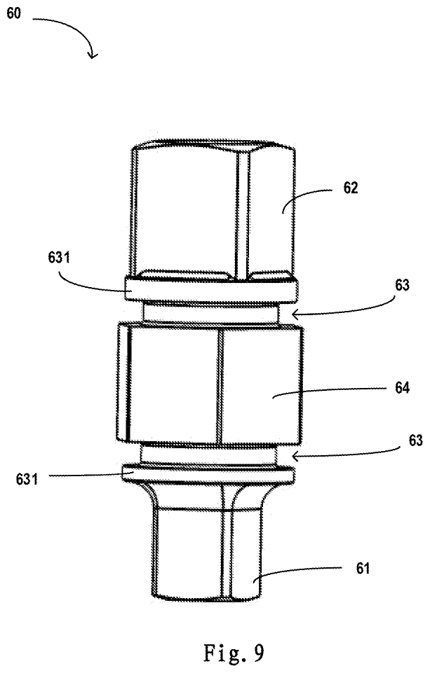

In some preferred embodiments, the power tool 100 allows the user to change the tool head 60. Therefore, the tool head 60 can be produced and sold independently of the power tool 100. The power tool 100 provided by the present disclosure may include the tool head 60, or may not include the tool head 60 and the tool head is used in cooperation with the tool head 60. FIG. 9 shows a possible structure of the tool head 60, wherein both ends of the tool head 60 are anvils in the form of prisms, and a first end 61 and a second end 62 have different sizes. The user may select one of the ends as an output end of the tool according to needs. A middle structure 64 of the tool head 60 is also formed as a prismatic structure. However, there are concave cylindrical grooves 63 between the ends 61, 62 and the middle structure 64 for adapting to a replacement operation assembly 70 of the power tool 100. Atop wall and a bottom wall of the cylindrical grooves 63 are defined by a flange 631 and a middle structure 64, respectively. When the tool head 60 is assembled on the power tool, one of the ends extends from the bottom of the power tool 100, and the other end and the middle portion 64 can be received in a central through hole 36 (see FIG. 5) of the output member main body 31.

The engagement relationship between the tool head 60 and the output member main body 31 is shown in FIG. 6A. The middle structure 64 of the tool head 60 constitutes a prism whose edges are caught by a close-to-bottom portion of the output member main body 31 so that the tool head 60 can rotate with the output member main body.

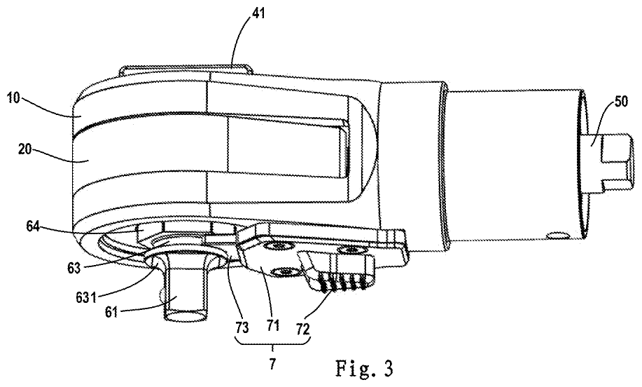

Turning back to FIG. 3, the power tool 100 includes the replacement operation assembly 70 for replacing the tool head 60. The replacement operation assembly 70 includes a fixed plate 71 fixed on the housing 10, a tongue 73 and an actuation portion 72. The actuation portion 72 can drive the tongue 73 to extend toward and retract from the tool head 60 relative to the fixed plate 71. The end of the tongue 73 is a concave arc that fits with the cylindrical groove 63 of the tool head 60. When the tongue 73 is engaged with the cylindrical groove 63, it allows the tool head 60 to rotate but restricts the axial movement of the tool head 60; when the tongue 73 and the cylindrical groove are disengaged, the tool head 60 is allowed to move axially to be replaced.

In the embodiment shown in FIGS. 1-9, the actuating member 42 for pushing the pawl 32 to actuate the pawl 32 between the first position and the second position is offset relative to a central axis X, that is to say, the actuating member 42 is located at an off-center position of the output member 30. Specifically, the actuating member 42 is located entirely inside the output member main body 31 and is disposed around the central axis X.

The actuating member 42 is away from the center of the output member 30, so that the output member main body 31 may have a thinner wall and the power tool is lighter. For example, in some embodiments, the wall thickness of the output member main body 31 may be 5-10 mm, preferably 5-7.5 mm, and more preferably 7 mm. The actuating member 42 yields the central space of the output member 30 to allow the central space to receive an idle end of a double-ended tool head; the wall of the output member main body 31 is thin so that the output member main body 31 has a larger inner diameter and can receive the idle end of the tool head having more sizes. For example, the inner diameter of the output member main body 31 having a wall thickness of about 7 mm may be 10 mm-15 mm, preferably 13 mm, so that the output member main body 31 can receive a tool head having an end sized 6 mm-7 mm (such as 6.35 mm, ¼-inch) and an end sized 9 mm-10 mm (such as 9.525 mm, ⅜-inch). Both ends of the tool head may be received in the central space of the output member main body 31.

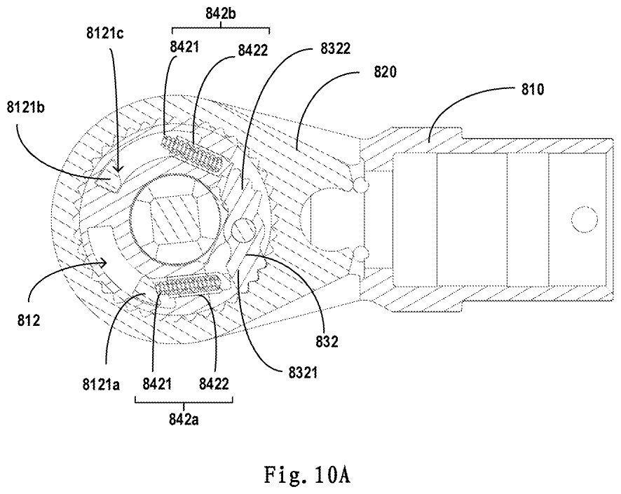

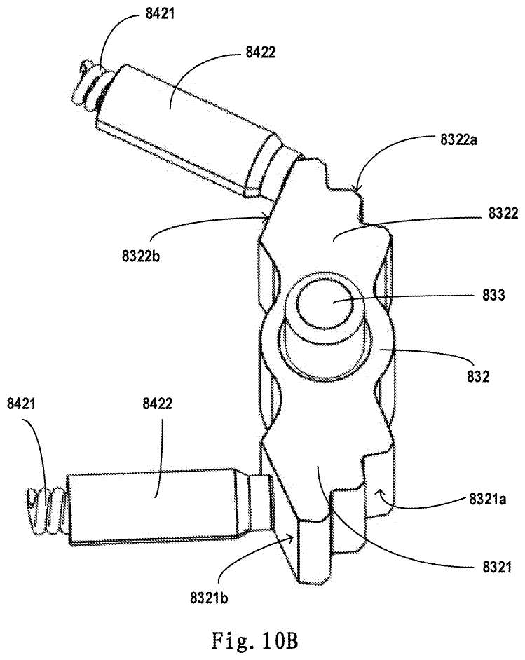

FIG. 10A and FIG. 10B show another possible preferred embodiment according to the present disclosure, wherein FIG. 10A has the same cross-sectional view as FIG. 6A, and FIG. 10B shows the cooperation of the actuating member and the pawl in FIG. 10A.

Referring to FIG. 10A, there are also two actuating members, each actuating member comprising a linear structure. Preferably, the actuating member includes a spring 8421 and a spring sleeve 8422 for partially receiving the spring 8421 and applying a force to the pawl 832. The first actuating member 842a and the second actuating member 842b are received within an actuating member groove 810 of the output member main body. A first force-applying end 8121a of the operation member is used to actuate the first actuating member 842a, and a second force-applying end 8121b of the operation member is used to actuate the second actuating member 842b. In order to adapt to such linear actuating members, the force-applying end of the operation member is also adjusted adaptively. For example, the cross-section of the force-applying end shown in FIG. 10A is a trapezoid, and a surface 8121c (corresponding to a hypotenuse of the trapezoid in the cross-section) of the force-applying end facing the linear structure is substantially perpendicular to the extension direction of the actuating member. Such an arrangement can improve the efficiency and stability in transmitting the lifting force. The structures of the input member 820 and the housing 810 of the power tool are the same as or similar to the input member 20 and the housing 10 in FIG. 1-FIG. 9.

The three-dimensional configuration of the actuating members and the pawl 832 is shown more clearly in FIG. 10B. Referring to FIG. 10B, for each actuating member, the spring 8421 is partially received in the spring sleeve 8422. The structure of the pawl 832 is the same as or similar to that of the pawl 32 shown in FIGS. 1-9. Specifically, the pawl 832 can pivotally swing slightly around a pivot 833. The pawl 832 includes a first wing portion 8321 and a second wing portion 8322 located on both sides of the pivot 833. A first pawl portion 8321a and a second pawl portion 8321b for engaging the ratchet teeth of the input member 820 are formed on outer side surfaces of circumferential end portions of the two wings, respectively. A first side surface 8321b and a second side surface 8322b are formed on inner side surfaces of the circumferential end portions of the two wings, respectively. The spring sleeves 8422 of the two actuating members can abut against the first side surface 8321b and the second side surface 8322b of the pawl 832, respectively.

The parts of the power tool shown in FIG. 10A-FIG. 10B are generally similar in structure to the structure shown in FIG. 1-FIG. 9 except that the actuating members and the force-applying end of the operation member are slightly different from those shown in FIG. 1-FIG. 9. The description of the embodiment shown in FIG. 1-FIG. 9 should also be understood as a description of the embodiment of FIG. 10A-FIG. 10B.

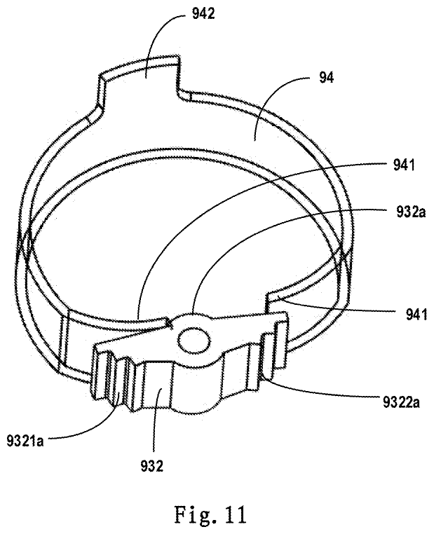

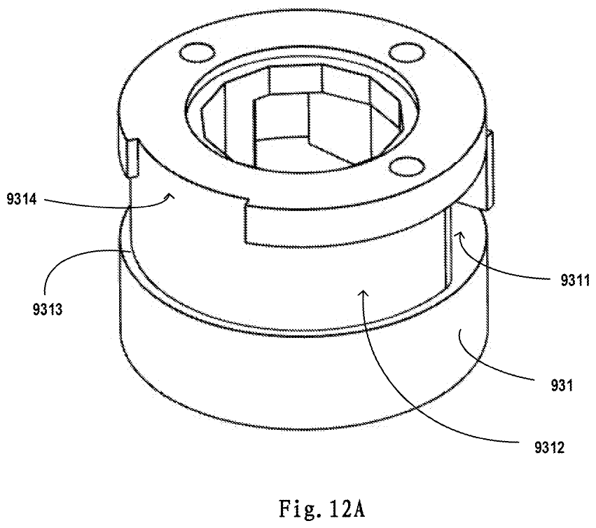

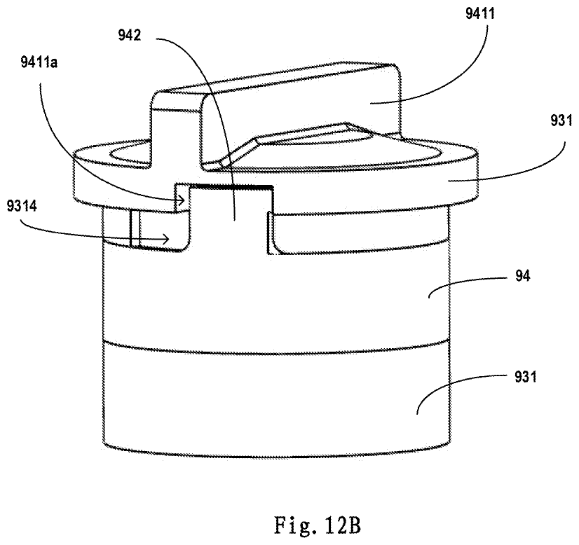

FIG. 11-FIG. 12B illustrate further preferred embodiments according to the present disclosure. The structure of the pawl 932 is the same as or similar to that of the pawl 32 in FIG. 1-FIG. 10B. The pawl 932 has a first pawl portion 9321a and a second pawl portion 9322a, and can pivotally swing slightly about a pivot. The pawl 932 has a pivot portion 932a for mounting the pivot, and the pivot portion 932 a slightly protrudes with respect to the body of the pawl 932. In some embodiments, the actuating member 94 for directly applying a force on the pawl 932 is an annular member with an opening, and the actuating member 94 may be, for example, a thin metal sheet, or be made of other slightly elastic materials. The actuating member 94 is positioned such that the pawl 932 is placed within the opening so that both ends 941 of the actuating member 94 can contact the pawl 932, respectively. Specifically, both ends 941 of the actuating member 94 can abut against the pivot portion 932a of the pawl 932, respectively, to retain the pawl 932 in the first position or the second position.

Referring to FIG. 12A and FIG. 12B, the engagement relationship between the actuating member 94, the output member main body 931, and the operation member 9411 is also slightly different from the example in FIGS. 1-10B. The actuating member 94 has an extension section 942 extending toward a top side, so that the operation member 9411 can abut against the extension section 942 in the circumferential direction. Preferably, the extension section 942 is an arc-shaped section extending around an axis. The actuating member 94 is disposed outside the output member main body 931. For example, referring to FIG. 12A, an actuating member groove 9312 may be provided on the outer circumference of the output member main body 931, and a bottom wall of the actuating member groove 9312 is bottom wall 9313. A notch 9314 is provided in a top flange defining the actuating member groove 9312 to allow the extension section 942 of the actuating member 84 to pass therethrough. The output member main body 931 is provided with a pawl receiving groove 9311.

Referring to FIG. 12B, the operation member 9411 is provided with a mating recess 9411a corresponding to the extending section 942. A circumferential dimension of the mating recess 9411a is consistent with that of the extension section 942, so that the actuating member 9411 can completely be driven by the rotation of the operation member 9411. The circumferential dimension of the notch 9413 of the output member main body 931 is greater than that of the extension section 942 to allow the extension section 942 to move circumferentially therein. As can be seen in FIG. 12B, the operation member 9411 is located on top of the output member main body 931, and the extension section 942 of the actuating member 94 extends through the notch 9314 and into the mating recess 9411a of the operation member 9411. That is, the notch 9314 of the output member main body 931 is used to engage the middle of the extension section 942 to allow the actuating member 94 to move circumferentially relative to the output member main body 931; the mating recess 9411a of the operation member 9411 is used to engage the top of the extension section 942 so that the actuating member 94 is secured relative to the operation member 9411.

Referring to FIG. 12B, after the actuating member 94 is assembled on the output member main body 931, the outer circumference of the actuating member 94 is flush with the outer circumference of the output member main body 931. The actuating member 94 and the output member main body 031 can jointly define a side surface of a substantially complete cylinder.

In the embodiment shown in FIG. 11-FIG. 12B, the actuating member 942 for pushing the pawl 932 to actuate the pawl 932 between the first position and the second position is offset relative to a central axis (specifically, disposed about the central axis), that is to say, the actuating member 942 is not located at the central position of the output member. Specifically, the actuating member 942 is located in the output member main body 931 (a notch 9314 also constitute a part of the output member main body 931) and is disposed around the central axis X.

The actuating member 942 is away from the center of the output member 30, so that the output member main body 931 may have a thinner wall and the power tool is lighter. For example, in some embodiments, the wall thickness of the output member main body 931 may be 5-10 mm, preferably 5-6 mm, and more preferably 5.27 mm. Room is made for the central space of the output member to allow the central space to receive an idle end of a double-ended tool head; the wall of the output member main body 931 is thin so that the output member main body 931 has a larger inner diameter and can receive the idle end of the tool head having more sizes. For example, the inner diameter of the output member main body 931 having a wall thickness of about 5.27 mm may be 10 mm-15 mm, preferably 13 mm, so that the output member main body 931 can receive a tool head having an ¼-inch end and a ⅜-inch head. Both ends of the tool head may be received in the central space of the output member main body 931.

The parts of the power tool shown in FIG. 11-FIG. 12B are generally similar in structure to the structure shown in FIG. 1-FIG. 9 except that the actuating members, the operation member and the output member main body are slightly different from those shown in FIG. 1-FIG. 9. The description of the embodiment shown in FIG. 1-FIG. 9 should also be understood as a description of the embodiment of FIG. 11-FIG. 12B.

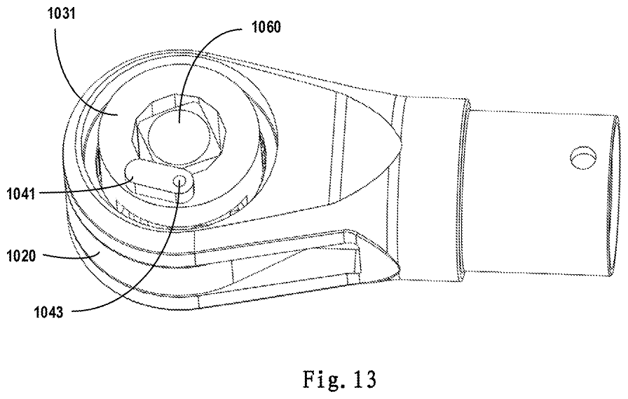

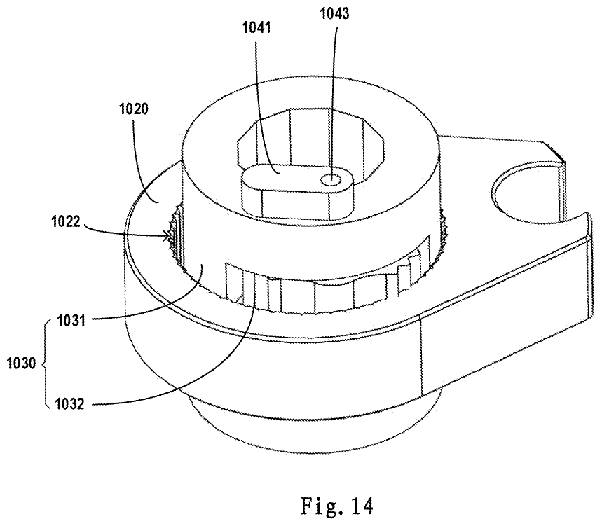

FIG. 13-FIG. 16 show a fourth preferred embodiment according to the present disclosure. Referring to FIG. 13 and FIG. 14, the input member 1020 still surrounds the output member 1030, the output member 1030 includes an output member main body 1031 and a pawl 1032 mounted on the side of the output member main body 1031, and the pawl 1032 selectively engages ratchet teeth 1022 on an inner surface of the input member 1020.

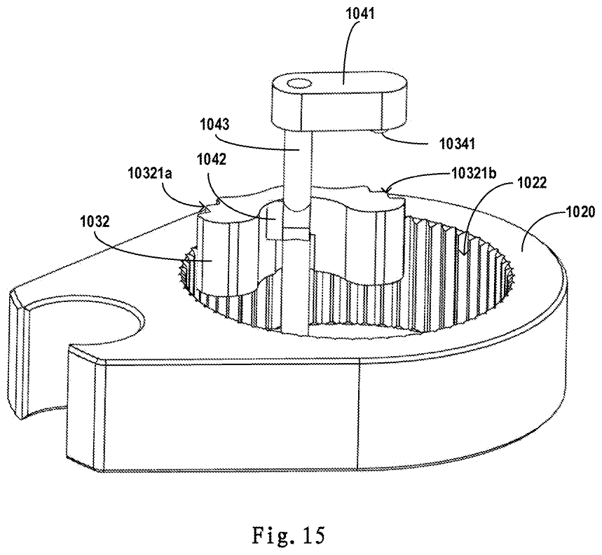

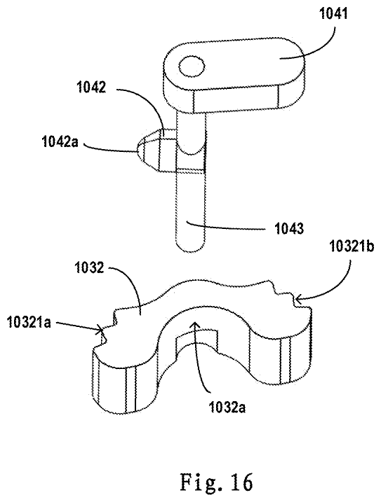

Continuing to refer to FIG. 15 and FIG. 16, in some embodiments, the operation member 1041 is fixed connected with the actuating member 1042 via a rod portion 1043, and the operation member 1041, the actuating member 1042 and the rod portion 1043 are formed into one piece.

Furthermore, the operation member 1041 is a toggle block that is exposed outward on the top of the working tool and can be toggled and pivoted by the user. The extension directions of the operation member 1041 and the actuating member 1042 are both substantially perpendicular to the rod portion 1043. The rod portion 1043 is preferably parallel to an axis of the output member main body. When the operation member 1041 is toggled, the actuating member 1042 is driven to pivot around a straight line where the extension direction of the rod portion 1043 lies. The top of the main body of the output member 1031 may be provided with a groove for receiving the elastic protrusion, and a bottom surface of the operation member 1041 is provided with a corresponding recessed portion. When the actuating member 1042 is in the first state or the second state, the elastic protrusion just pushes into the bottom surface of the operation member 1041 (the elastic protrusion 10341 is shown in FIG. 15) to fix the operation member 1041 relative to the output member main body 1031.

In these embodiments, the pawl 1032 is a generally arcuate structure about the rod portion 1043 and is capable of swinging about the rod portion 1043. The first pawl portion 10321A and the second pawl portion 10321b are respectively formed on outer side surfaces of both circumferential end portions of the pawl 1032, and the actuating member 1042 can abut against the inner side surface 1032a of the pawl 1032 to retain the pawl 1032 at the first position and the second position, Preferably, the inner side surface 1032a of the pawl 1032 is an arcuate surface surrounding the rod portion 1043. The arrangement of the arcuate surface can ensure smooth contact of the actuating member 1042 and the pawl 1032.

In these embodiments, although the pawl 1032 also make a swinging motion to achieve the switching between the first position and second position, the pawl 1032 is no longer connected with the output member main body 1031 via a pivot. Any connection structure may not be disposed between the pawl 1032 and the output member main body 1031. Instead, the pawl 1032 is substantially fixed relative to the position of the output member main body 1031 only by means of the limiting function of the input member 1020 and the actuating member 1042.

Returning to FIG. 13, when the actuating member 1042 is retained in the first state or the second state, the operation member 1041 make room for a top of the tool head 1060 to allow the tool head 1060 to extend outward from the top of the power tool to serve as an output end. Certainly, it is also possible to allow the tool head 1060 to extend outward from a bottom side of the power tool to serve as an output end.

In the embodiment shown in FIG. 13-FIG. 16B, the actuating member 1042 for pushing the pawl 1032 to actuate the pawl 1032 between the first position and the second position is offset relative to a central axis, that is to say, the actuating member 1042 is located at an off-center position of the output member 1030. Specifically, the actuating member 1042 is substantially located within the output member main body 1030 (a rod portion 1043 for actuating the actuating member runs through the wall of the output member main body 1030; it can be seen that the actuating member 1042 at the bottom end of the rod portion 1043 is substantially located within the output member main body 1030).

The actuating member 1042 actuates the pawl 1032 by getting away from the center of the output member 1030 and adjacent to an inner side surface of the output member main body 1031, so that the output member main body 1031 may have a thinner wall and the power tool is lighter. For example, in some embodiments, the wall thickness of the output member main body 1031 may be 5-10 mm, preferably 8-9 mm, and more preferably 8.15 mm. The actuating member 1042 makes room for the central space of the output member 1030 to allow the central space 1030 to receive an idle end of a double-ended tool head; the wall of the output member main body 1031 is thin so that the output member main body 1031 has a larger inner diameter and can receive the idle end of the tool head having more sizes. For example, the inner diameter of the output member main body 1031 having a wall thickness of about 8.15 mm may be 10 mm-15 mm, preferably 13 mm, so that the output member main body 1031 can receive a tool head having two ends having a ¼-inch bottom surface side and a ⅜-inch bottom surface side. Both ends of the tool head may be received in the central space of the output member main body 1031.

The parts of the power tool shown in FIG. 13-FIG. 16 are generally similar in structure to the structure shown in FIG. 1-FIG. 9 except that the actuating members, the operation member and the output member main body are slightly different from those shown in FIG. 1-FIG. 9. The description of the embodiment shown in FIG. 1-FIG. 9 should also be understood as a description of the embodiment of FIG. 13-FIG. 16.

The embodiments shown in FIG. 1A to FIG. 16 and the related depictions of these embodiments are only exemplary and non-limiting, and those skilled in the art can recombine the features of the above-mentioned different embodiments to obtain new embodiments which are also within the protection scope of the present disclosure. For example, there may be a power tool in which the actuating member comprises two sections, wherein each section has an extension section extending toward the top side, and the operation member abuts against the extension section in the circumferential direction to drive the actuating member. Furthermore, in such a power tool, the actuating member may abut against the pivot portion of the pawl to actuate the pawl. There may also be a power tool in which the actuating member is a ring shape with an opening, wherein the operation member has an extension section extending towards the bottom side to the actuating member groove, and the extension section is used to abut against the actuating member in the circumferential direction. Furthermore, in such a power tool, the actuating member may abut against the first side surface and second side surface of the pawl to actuate the pawl; there may also be a power tool in which the actuating member for actuating the pawl may not be completely located within the output member main body, for example the actuating member may be partially located within the output member main body, or the actuating member may be proximate the inner sidewall of the output member main body, as long as room is made for the center of the output member main body.

Those skilled in the art can also make some modifications to the above-mentioned different embodiments, and these modifications also fall within the protection scope of the present disclosure. For example, the operation member does not necessarily include a knob and a toggle block, and it may include a sliding actuation structure, a pressing actuation structure or the like; the movement mode of the pawl relative to the output member main body is not necessarily pivoting or swinging, and the pawl may slightly translate relative to the output member main body to achieve position switching.

The power tool according to the present disclosure provides a torque transmission mode different from conventional ratchet-pawl transmissions. The ratchet teeth are provided on the inner circumference of the annular input member of the present disclosure, the input member surrounds the output member, and the pawl engages the ratchet teeth at inner side of the input member. Due to such an arrangement, the positional relationship between the input member and the output member is stable so that they are not prone to disengage; it is easier for an operator to switch the torque transmission direction, and it is easy to ensure the full contact and engagement of the pawl and the ratchet; the performance and service life of the power tool can be optimized.

Moreover, in the present disclosure, the actuating member for actuating the pawl is disposed offset from the center axis, that is, the actuating member is located at an off-center position of the output member. The actuating member may be located at least partially within the hollow output member main body to drive the pawl, so that the output member may have a thinner wall and the power tool is lighter. The actuating member makes room for the central space of the output member to allow the central space to receive an idle end of a double-ended tool head; the wall of the output member is thin so that the output member has a larger inner diameter and can receive the idle end of the tool head having more sizes.

The present disclosure still further provides various preferred arrangements for the switching of the torque transmission direction to meet various use and production demands.

The above depictions of various embodiments of the present disclosure are provided to those having ordinary skill in the art for a depiction purpose, and are not intended to exclude other embodiments from the present prevention or limit the present prevention to a single disclosed embodiment. As described above, various alternatives and modifications of the present prevention will be apparent to those of ordinary skill in the art. Accordingly, although some alternative embodiments have been described in detail, those having ordinary skill in the art will understand or readily develop other embodiments. The prevention is intended to cover all alternatives, modifications and variations of the present prevention described herein, as well as other embodiments falling within the spirit and scope of the present prevention described herein.

1. A power tool, wherein the power tool comprises:
an input member substantially constituting an annular shape and configured to be driven by a power source of the power tool to rotate in a first direction and a second direction opposite to the first direction, ratchet teeth being disposed on an inner circumference of the input member;
an output member surrounded by the input member and configured to mount a tool head thereon to move the tool head, the output member comprising a pawl having a first pawl portion and a second pawl portion;
an actuating member capable of abutting against different portions of the pawl to respectively cause the pawl to be positioned in a first position and a second position relative to the input member, wherein the actuating member is offset from a central axis of the input member,
wherein when the pawl is retained in the first position, the first pawl portion is capable of engaging with the ratchet teeth to only allow rotation of the input member in the first direction to be transmitted to the output member; when the pawl is retained in the second position, the second pawl portion is capable of engaging with the ratchet teeth to only allow rotation of the input member in the second direction to be transmitted to the output member.

2. The power tool according to claim 1, wherein the output member comprises a substantially cylindrical hollow output member main body, a receiving groove is provided on a side surface of the output member main body, and the pawl is disposed in the receiving groove, and the actuating member is located at least partially in the output member main body,
wherein a wall thickness of the output member main body is 5 mm-9 mm.

3. The power tool according to claim 1, wherein the power tool further comprises:
an operation member for a user to operate to drive the actuating member,
wherein the actuating member is configured to elastically apply a force on the pawl.

4. The power tool according to claim 3, wherein the actuating member abuts against the operation member.

5. The power tool according to claim 4, wherein the actuating member comprises two actuating members, wherein:
each of the actuating members comprises an arcuate structure extending about an axis of the input member, and wherein the actuating member comprises a spring and a rigid force-applying section in direct contact with the pawl.

6. The power tool according to claim 4, wherein the actuating member is an annular member substantially surrounding the central axis and having an opening, the actuating member being positioned such that the pawl is disposed in the opening so that both ends of the actuating member can respectively contact the pawl.

7. The power tool according to claim 4, wherein the operation member is exposed from a top of the power tool, an actuating member groove extending in a plane perpendicular to the central axis and allowing the actuating member to move therein is disposed in the output member main body, wherein:
the operation member has an extension section extending towards a bottom side to the actuating member groove, the extension section being configured to abut against the actuating member in a circumferential direction.

8. The power tool according to claim 7, wherein the actuating member is linear, the operation member has the extension section, and a surface of a distal end of the extension section facing the actuating member is substantially perpendicular to an extension direction of the actuating member.

9. The power tool according to claim 4, wherein the operation member is a knob, two recessed portions are formed on a bottom surface of the knob and elastic protrusions are provided on a top surface of the output member main body; when the elastic protrusions are partially placed in the recessed portions, the knob is fixed relative to the output member to retain the actuating members in place.

10. The power tool according to claim 4, wherein the pawl is configured to swing about a pivot fixed to the output member main body, the pawl comprises a first wing portion and a second wing portion located on both sides of the pivot, the first pawl portion is formed on an outer side surface of a circumferential end portion of the first wing portion, and the second pawl portion is formed on an outer side surface of a circumferential end portion of the second wing portion, wherein
the actuating member is capable of abutting against an inner side surface of the circumferential end portion of the first wing portion to retain the pawl in the first position, and capable of abutting against an inner side surface of the circumferential end portion of the second wing portion to retain the pawl in the second position.

11. The power tool according to claim 3, wherein the operation member and the actuating member are fixedly connected as one piece via a rod portion,
wherein the operation member comprises a toggle block exposed outward at the top of the power tool, the actuating member comprises a pin, a force-applying end of the pin in contact with the pawl is provided with an elastic contact, and the pin is driven to pivot about a straight line where an extension direction of the rod portion lies, when the toggle block is toggled.

12. The power tool according to claim 11, wherein the pawl is a substantially arcuate structure surrounding the rod portion and is capable of swinging around the rod portion, the first pawl portion and the second pawl portion are respectively formed on outer side surfaces of circumferential end portions of the pawl, and the actuating member can abut against the inner side surface of the pawl to retain the pawl at the first position and the second position.

13. The power tool according to claim 11, wherein when the actuating member is retained in a way that the pawl is located in the first position or the second position, the operation member makes room for a top of the tool head to allow the working head to extend outward from the top of the power tool to serve as an output end, and the tool head can also extend outward from a bottom of the power tool to serve as an output end.

14. The power tool according to claim 1, wherein the power tool comprises a replacement operation assembly operable to allow the tool head to be replaced, wherein both ends of the tool head have different dimensions, and the power tool allows the tool head to be mounted on the power tool with different ends as output.

15. The power tool according to claim 14, wherein a portion of the tool head extending out of the output member has a cylindrical section that is radially inwardly recessed relative to portions at its both axial side, and
the replacement operation assembly comprises a tongue, a distal end of the tongue is a concave arc adapted to the cylindrical portion, and the tongue is configured to extend towards and retract from the cylindrical portion,
wherein, when the tongue is engaged on the cylindrical portion, the tool head is allowed to rotate but axial movement of the tool head is limited; when the tongue is disengaged from the cylindrical portion, the tool head is allowed to moved axially to be replaced.

16. The power tool according to claim 1, wherein the power tool is a wrench, the power source is a manual power source or an electric power source, wherein the input member swings alternately in the first direction and the second direction, and wherein an eccentric transmission mechanism is disposed between the power source and the input member.

17. The power tool according to claim 5, wherein an end of the force-applying section abuts against an end of the spring or the force-applying section has a portion extending into an interior of the spring.

18. The power tool according to claim 17, wherein the actuating member is linear, and wherein the actuating member comprises a spring and a spring sleeve for partially receiving the spring and applying a force to the pawl.

19. The power tool according to claim 7, wherein the actuating member has an extension section extending toward a top side out of the actuating member groove so that the operation member can abut against the extension section in a circumferential direction, wherein the extension section is an arcuate section extending about the central axis, and wherein the power tool comprises a housing with a top provided with a protective protrusion at least partially surrounding the operation member.

20. The power tool according to claim 10, wherein the actuating member is capable of abutting against a pivot mounting portion of the pawl to retain the pawl in the first position or the second position, and wherein the pivot is parallel to the central axis.
